(19) United States
(12) Patent Application Publication
(10) Pub. No.: US 2011/0175253 A1
(43) Pub. Date: Jul. 21, 2011

(54) STRAND GUIDE ASSEMBLY AND METHOD OF CONTROLLING A FLOW OF MOLTEN THERMOPLASTIC

(76) Inventors: Thomas H. Bilk, Gibraltar, MI (US); Joaquin L. Gracia, Belleville, MI (US)

(21) Appl. No.: 13/008,098

(22) Filed: Jan. 18, 2011

Related U.S. Application Data
(60) Provisional application No. 61/295,831, filed on Jan. 18, 2010.

(51) Int. Cl. B29C 47/00

(52) U.S. Cl. 264/177.1; 425/71

(57) ABSTRACT

A strand guide assembly, a guiding system, and a method of controlling a flow of molten thermoplastic to form first and second strands moving from an extruder to a finishing apparatus is disclosed. The method comprises the steps of extruding molten thermoplastic to form the strands, routing the strands from the extruder to the finishing apparatus, and cooling the strands. The method comprises the steps of guiding the first strand across one shaped step when guide segments are in a single-step configuration or guiding the first strand across an abutting pair of shaped steps when guide segments are in a dual-step configuration to separate the first and second strands and guiding the second strand across another one of the shaped steps when in the single-step configuration or guiding the second strand across another abutting pair of shaped steps when in the dual-step configuration to separate the first and second strands.

### CROSS REFERENCE TO RELATED APPLICATION

This application claims the benefit of U.S. Provisional Patent Application Serial No. 61/295,831, filed on Jan. 18, 2010, the disclosure of which is hereby incorporated by reference in its entirety.

### BACKGROUND OF THE INVENTION

1. Field of the Invention

The subject invention generally relates to a method of controlling a flow of molten thermoplastic using strand guide assemblies for guiding a plurality of strands of molten thermoplastic.

2. Description of the Related Art

Strand guides are known for guiding strands during various manufacturing processes. For example, one type of strand guide includes a rod defining grooves cut through a portion of the rod for guiding the strands through the grooves. Typically, the rod is formed of a material such as steel or nylon which wears away rapidly as the strands move through the grooves. The rod is formed of a unitary configuration such that the entire strand guide must be replaced when the wear becomes too great. Further, the grooves of the rod only accommodate strands defining a certain diameter. If the strands define a diameter larger than the grooves, the entire strand guide must be replaced with another strand guide capable of accommodating the strands defining the larger diameter.

Therefore, there remains an opportunity to develop an improved strand guide assembly.

### SUMMARY OF THE INVENTION AND ADVANTAGES

The present invention provides for a method of controlling a flow of molten thermoplastic to form at least a first strand and a second strand moving from an extruder having a die plate to a finishing apparatus. A plurality of guide segments are formed of a ceramic material and abut each other on a support. Each of the guide segments have a first end, a second end, and a shaped step defined between the first and second ends. The guide segments are configured on the support to define a single-step configuration presenting one of the shaped steps and a dual-step configuration presenting an abutting pair of the shaped steps. The method comprises the steps of extruding the molten thermoplastic through the die plate to form the strands, routing the strands from the extruder to the finishing apparatus, and cooling the strands. The method further comprises the step of guiding the first strand across the one of the shaped steps when the guide segments are in the single-step configuration or guiding the first strand across the abutting pair of the shaped steps when the guide segments are in the dual-step configuration to separate the first strand from the second strand. The method also comprises the step of guiding the second strand across another one of the shaped steps when the guide segments are in the single-step configuration or guiding the second strand across another abutting pair of the shaped steps when the guide segments are in the dual-step configuration to separate the second strand from the first strand.

The present invention also provides for a strand guide assembly and a guiding system for guiding at least one of the strands extruded from the extruder to the finishing apparatus. The system includes the support and the guide segments abutting each other. Each of the guide segments are formed of the ceramic material and have the first end, the second end, and the shaped step defined between the first and second ends. The shaped step of each of the guide segments receives one of the strands for separating the strands.

The strand guide assembly of the present invention therefore provides for a more durable and more accommodating strand guide assembly as compared to the known strand guides as discussed in the background of the invention section. For example, the guide segments of the present invention are formed of the ceramic material which increases durability of the guide segments thus increasing the life of the strand guide assembly. As another example, the guide segments allow for easy replacement of any damaged guide segment without having to replace the entire strand guide assembly. As yet another example, the guide segments are reversible to define the single-step configuration presenting one of the shaped steps and the dual-step configuration presenting the abutting pair of the shaped steps thus accommodating different diameters of strands which provides for a more versatile strand guide assembly.

### BRIEF DESCRIPTION OF THE DRAWINGS

Other advantages of the present invention will be readily appreciated, as the same becomes better understood by reference to the following detailed description when considered in connection with the accompanying drawings.

FIG. 1A is a partial broken perspective view of a guiding system routing a plurality of strands from an extruder to a finishing apparatus.

FIG. 1B is a partial broke perspective view of the extruder and a container filled with water and a first strand guide assembly partially submerged in the water with the strands guided under the first strand guide assembly.

FIG. 1C is a partial broken perspective view of a strand tree and the finishing apparatus with the strands guided over the strand tree and routed into the finishing apparatus.

FIG. 1D is a partial broken perspective view of the container with the strands guided under another first strand guide assembly within the water and guided over a third strand guide assembly before entering a blower.

FIG. 2 is a partial exploded plan view of one strand guide assembly having a plurality of guide segments in a single-step configuration for guiding the strands of a first diameter and a dual-step configuration for guiding the strands of a second diameter larger than the first diameter.

FIG. 3 is a broken plan view of one strand guide assembly.

FIG. 4 is a cross-sectional view of a guide segment.

FIG. 5 is a cross-sectional view of the container with one first strand guide assembly submerged deeper in the water than another first strand guide assembly.

FIG. 6 is a partial broken perspective view of the guiding system during extrusion of a first batch of molten thermoplastic.

FIG. 7 is a schematic view of the finishing apparatus.

### DETAILED DESCRIPTION OF THE INVENTION

Referring to the Figures, wherein like numerals indicate like or corresponding parts throughout the several views, a guiding system 10 and a strand guide assembly 12 are generally shown. The strand guide assembly 12 is utilized in the guiding system 10. Therefore, the structure and function of the strand guide assembly 12 will be discussed before the guiding system 10.

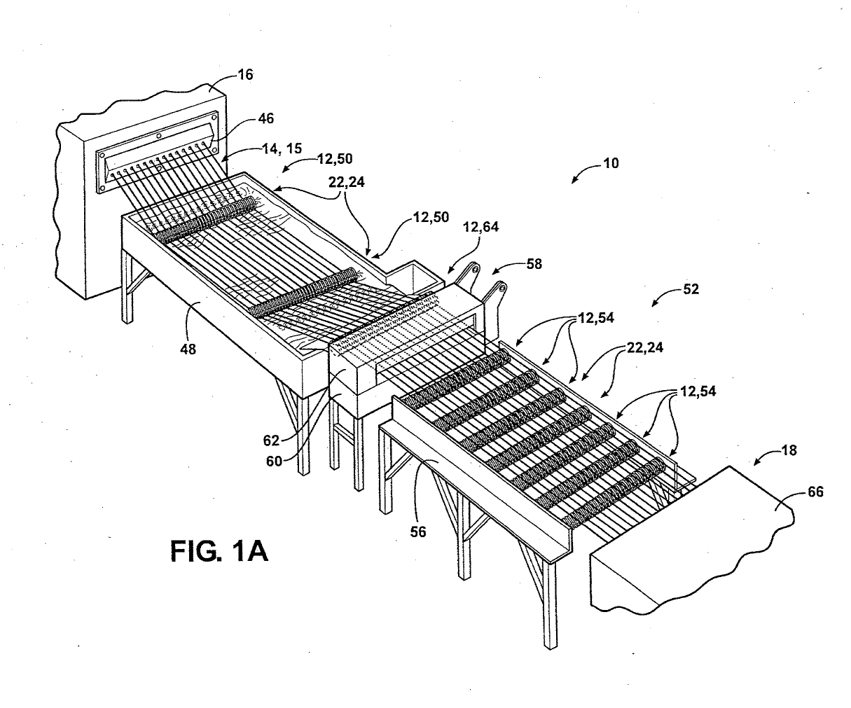

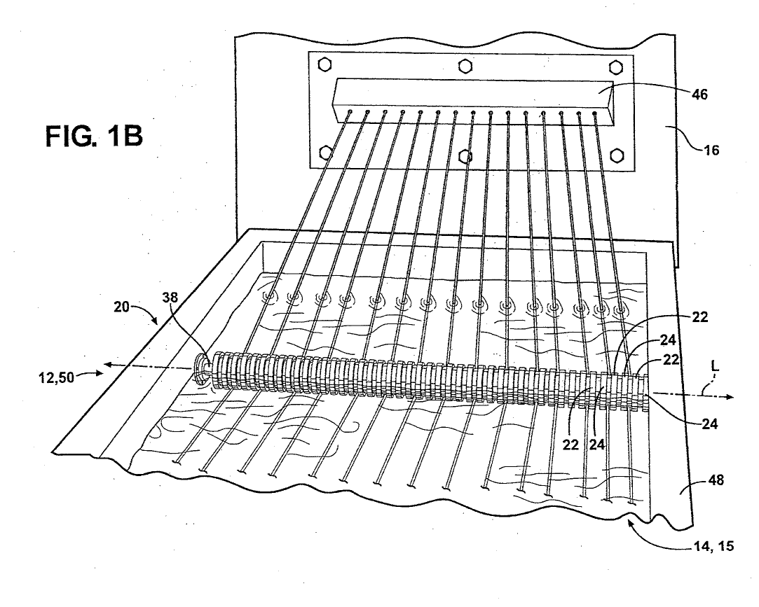

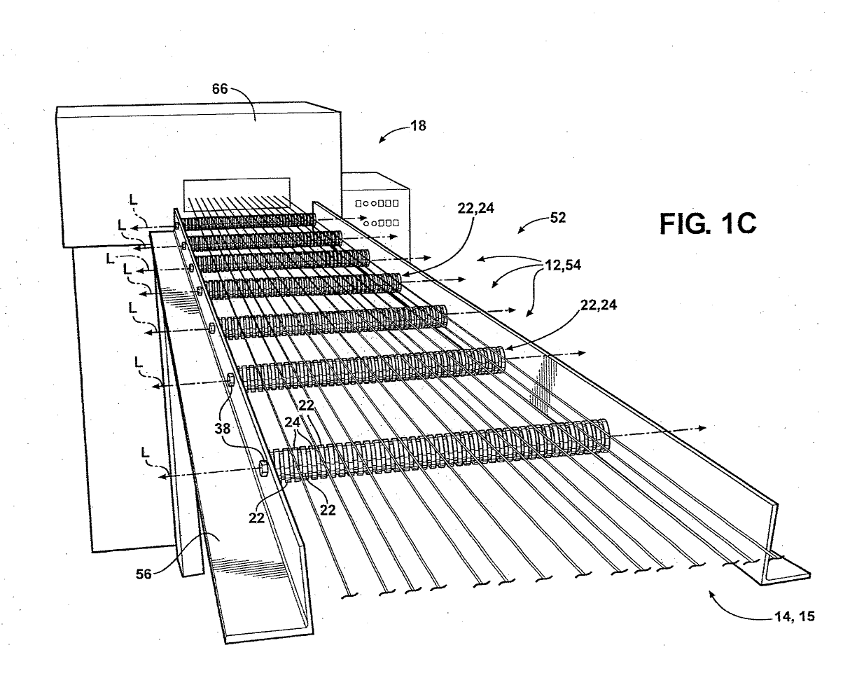

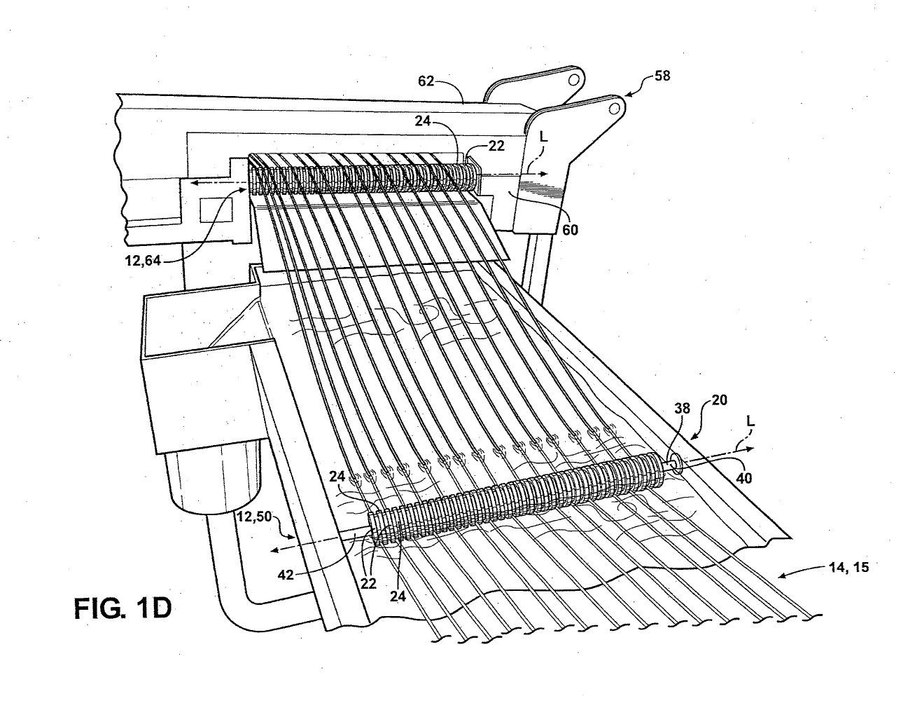

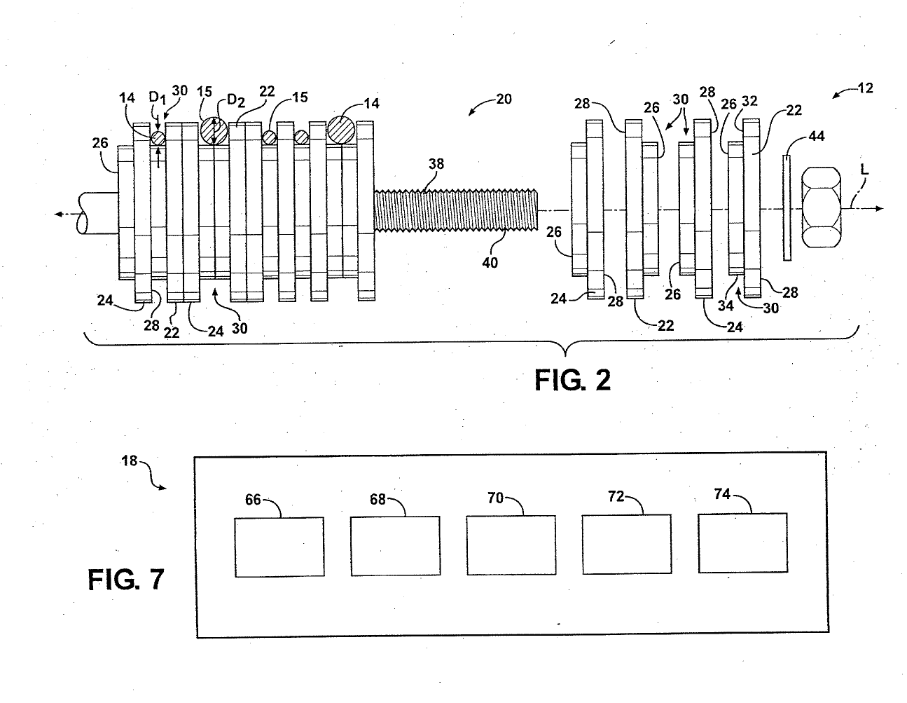

Referring to FIGS. 1A and 2, the strand guide assembly 12 guides at least one strand 14, 15 extruded from an extruder 16 with the strand 14, 15 having one of a first diameter D₁ and a second diameter D₂ larger than the first diameter D₁. For example, as shown in FIG. 2, the strand 14, 15 can be further defined as a first strand 14 and a second strand 15 each having the first diameter D₁, or the strand 14, 15 can be further defined as the first strand 14 and the second strand 15 each having the second diameter D₂. It has also been contemplated that the first strand 14 can define the first diameter D₁ and the second strand 15 can define the second diameter D₂, or vise versa. Typically, the strand guide assembly 12 guides the strand 14, 15 routed from the extruder 16 to a finishing apparatus 18 as also discussed further below with the guiding system 10.

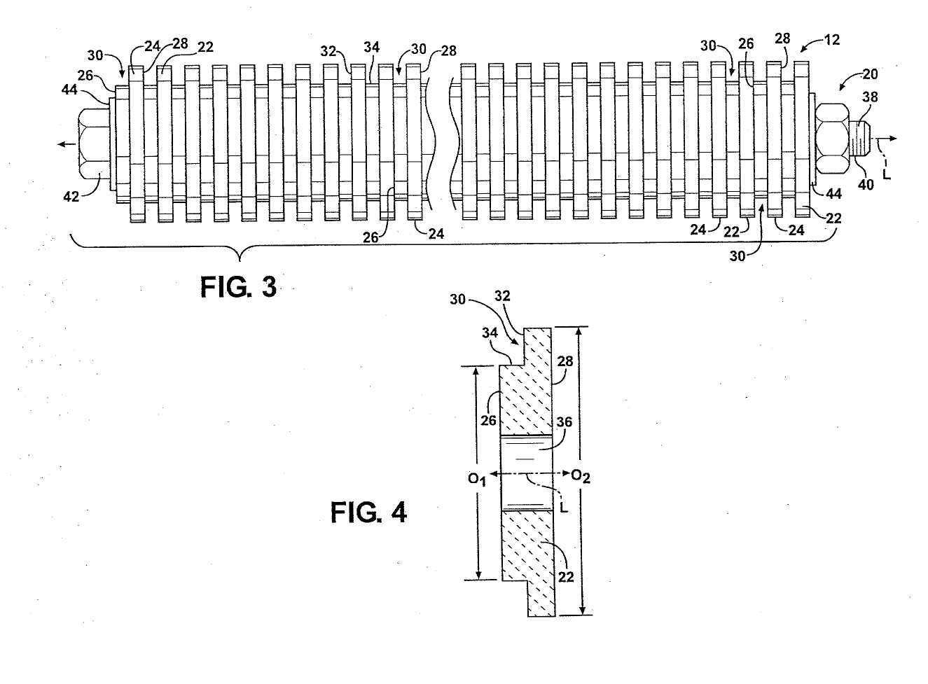

Also referring to FIGS. 3 and 4, the strand guide assembly 12 includes a support 20 defining a longitudinal axis L. The strand guide assembly 12 further includes a first guide segment 22 and a second guide segment 24 each disposed on the support 20 and abutting each other along the longitudinal axis L. The strand 14, 15 is guided across the first and second guide segments 22, 24 as the strand 14, 15 is routed from the extruder 16 to the finishing apparatus 18. Each of the first and second guide segments 22, 24 are formed of a ceramic material which resists wear better than other materials such as steel and nylon. Hence, the ceramic material increases durability of the first and second guide segments 22, 24 as the strand 14, 15 is guided across the first and second guide segments 22, 24 thus increasing the life of the first and second guide segments 22, 24. In certain embodiments, the ceramic material of the first and second guide segments 22, 24 are typically formed of alumina silica ceramic. More typically, the ceramic material of the first and second guide segments 22, 24 comprise about 95% alumina silica ceramic. In addition, in certain embodiments, the first and second guide segments 22, 24 typically have a Rockwell Hardness of about 45N, Scale 82.

The first and second guide segments 22, 24 each have a first end 26 and a second end 28 spaced from each other along the longitudinal axis L. In addition, the first and second guide segments 22, 24 each have a step 30 defined between the first and second ends 26, 28 of each of the first and second guide segments 22, 24 for guiding the strand 14, 15. In certain embodiments, the step 30 of each of the first and second guide segments 22, 24 are further defined as an L-shaped step 30 defined between the first and second ends 26, 28 for guiding the strand 14, 15 across the L-shaped step 30. In other words, the strand 14, 15 is disposed in the L-shaped step 30.

Typically, the L-shaped step 30 of each of the first and second guide segments 22, 24 include a vertical portion 32 and a horizontal portion 34 abutting each other. The vertical portion 32 is disposed transverse to the longitudinal axis L and the horizontal portion 34 is disposed substantially parallel to the longitudinal axis L between the vertical portion 32 and the first end 26. As best shown in FIG. 3, the first end 26 of the first guide segment 22 abuts the second end 28 of the second guide segment 24 with the horizontal portion 34 of the first guide segment 22 spaced from the horizontal portion 34 of the second guide segment 24 such that the L-shaped step 30 of the first guide segment 22 guides or receives the strand 14, 15 of the first diameter D₁. Referring back to FIG. 2, the first end 26 of the first and second guide segments 22, 24 abut each other with the horizontal portion 34 of the first and second guide segments 22, 24 aligning with each other such that the L-shaped step 30 of each of the first and second guide segments 22, 24 cooperate for guiding or receiving the strand 14, 15 of the second diameter D₂.

Also referring to FIG. 4, typically, each of the first and second guide segments 22, 24 have a first outer diameter O₁ and a second outer diameter O₂ greater than the first outer diameter O₁ to further define the L-shaped step 30 for guiding the strand 14, 15. The first end 26 is adjacent the first outer diameter O₁ and the second end 28 is adjacent the second outer diameter O₂ such that the L-shaped step 30 is defined between the first and second ends 26, 28. The vertical portion 32 is disposed between the first and second outer diameters O₁, O₂ and the horizontal portion 34 is parallel to the first outer diameter O₁. Optionally, a width of the portion of the first and second guide segments 22, 24 having the second outer diameter 0₂ can vary for changing the spacing between the strands 14, 15. It has also been contemplated that a width of the portion of the first and second guide segments 22, 24 having the first outer diameter O₁ can change for accommodating the strands 14, 15.

The first and second ends 26, 28 of each of the first and second guide segments 22, 24 define a flat configuration. The flat configuration of one of the first and second ends 26, 28 of the first guide segment 22 abuts the flat configuration of the second end 28 of the second guide segment 24 such that each of the first and second guide segments 22, 24 define only a singular step 30 for guiding the strand 14, 15 of one of the first and second diameters D₁, D₂. In other words, the first guide segment 22 defines only one-single L-shaped step 30 and the second guide segment 24 defines only one-single L-shaped step 30.

In addition, the first and second guide segments 22, 24 each typically define an aperture 36 along the longitudinal axis L for mounting the first and second guide segments 22, 24 on the support 20. As best shown in FIG. 3, in certain embodiments, the support 20 is further defined as a rod 38 having a first distal end 40 and a second distal end 42 spaced from each other relative to the longitudinal axis L. The rod 38 is disposed through the aperture 36 of each of the first and second guide segments 22, 24 for supporting the first and second guide segments 22, 24. Although not required, at least one washer 44 is mounted on the rod 38 adjacent one of the first and second distal ends 40, 42 of the rod 38. In certain embodiments, the washer 44 is further defined as a plurality of washer 44 with one washer 44 disposed adjacent the first distal end 40 and another washer 44 disposed adjacent the second distal end 42.

The first and second guide segments 22, 24 are separate individual parts which are identical in configuration to each other. Having individual guide segments 22, 24 allows for easy replaceability of damaged guide segments 22, 24 without having to replace the entire strand guide assembly 12. The damaged guide segments 22, 24 are simply replaced with new guide segments 22, 24 thus extending the life of the strand guide assembly 12.

Further, having individual first and second guide segments 22, 24 allows the strand guide assembly 12 to accommodate different diameter strands 14, 15 by reversing at least one of the first and second guide segments 22, 24. In other words, the first and second guide segments 22, 24 are reversible between a single-step configuration and a dual-step configuration as shown in FIG. 2. The single-step configuration accommodates the strand 14, 15 of the first diameter D₁ such that the first end 26 of the first guide segment 22 abuts the second end 28 of the second guide segment 24 for guiding the strand 14, 15 of the first diameter D₁ across the step 30 of the first guide segment 22. The dual-step configuration accommodates the strand 14, 15 of the second diameter D₂ such that the first end 26 of the first guide segment 22 abuts the first end 26 of the second guide segment 24 for guiding the strand 14, 15 of the second diameter D₂ across the step 30 of each of the first and second guide segments 22, 24.

In one embodiment, as shown in FIG. 3, the first and second guide segments 22, 24 are further defined as a plurality of guide segments 22, 24 with all of the guide segments 22, 24 disposed in the single-step configuration for guiding a plurality of strands 14, 15 having the first diameter D₁. In another embodiment, as shown in FIG. 2, some of the guide segments 22, 24 are disposed in the single-step configuration and some of the guide segments 22, 24 are disposed in the dual-step configuration such that the strand guide assembly 12 accommodates strands 14, 15 having both the first and second diameters D₁, D₂. In yet another embodiment, even though not illustrated, all of the guide segments 22, 24 can be disposed in the dual-step configuration for guiding the strands 14, 15 having the second diameter D₂. Optionally, a plurality of spacers (not shown) can be utilized between the guide segments 22, 24 for changing the spacing between the strands 14, 15.

As briefly mentioned above, the present invention also discloses the guiding system 10 utilizing the strand guide assembly 12 as discussed above. The strand guide assembly 12 is further defined as a plurality of strand guide assemblies 12 for guiding the strands 14, 15 routed from the extruder 16 to the finishing apparatus 18 as discussed further below. The number of strand guide assemblies 12 utilized for guiding the strands 14, 15 routed from the extruder 16 to the finishing apparatus 18 can vary according to the manufacturing process. The strand guide assemblies 12 discussed below all have the same structure as the strand guide assembly 12 discussed above. The locations of the strand guide assemblies 12 within the guiding system 10 will be focused on below. In addition, the number of guide segments 22, 24 utilized for the strand guide assemblies 12 can vary depending on the number of strands 14, 15 being extruded from the extruder 16.

Referring to FIGS. 1A, 1B, and 2, the guiding system 10 has the strands 14, 15 formed of a molten thermoplastic with the strands 14, 15 defining at least one of the first diameter D₁ and the second diameter D₂ being larger than the first diameter D₁. More specifically, the guiding system 10 includes the extruder 16 for extruding the molten thermoplastic to form the strands 14, 15. Typically, the extruder 16 has a die plate 46 for extruding the molten thermoplastic through the die plate 46 to form the strands 14, 15. The strands 14, 15 being extruded through the die plate 46 can be any suitable diameter and more typically, have diameters ranging between about 2.5 mm to about 4.0 mm. It is to be appreciated that the number of guide segments 22, 24 utilized in the strand guide assemblies 12 will be greater than the number of strands 14, 15 extruded through the die plate 46.

Typically, the molten thermoplastic is formed into strands 14, 15 as either a filled product or an unfilled product. Strands 14, 15 formed as the filled product are more abrasive than strands 14, 15 formed as the unfilled product. The filled product includes a reinforcing material added to the molten thermoplastic for forming strands 14, 15 which are strengthened. The unfilled product lacks the reinforcing material and form strands 14, 15 which are un-strengthened. The guide segments 22, 24 are formed of the ceramic material which resists wear better than other materials as discussed above, thus reducing hang up of the strands 14, 15 on the guide segments 22, 24 as the strands 14, 15 are guided across the strand guide assemblies 12 in either the filled or unfilled product form. The reinforcing material is typically selected from the group of glass, minerals, and combinations thereof. In certain embodiments, the minerals can be further defined as amorphous silica, aluminum silicate, magnesium carbonate, kaolin, calcium carbonate, powdered quartz, mica, feldspar, clay, and combinations thereof. Typically, the mineral is further defined as calcium carbonate for strengthening the strands 14, 15. Additionally, the molten thermoplastic is typically further defined as molten nylon.

The raw material utilized to create the molten thermoplastic can be mixed prior to adding the raw materials into the extruder 16 and/or the raw materials can be added and mixed during any stage of the extrusion process. In addition, the reinforcing materials can be mixed prior to adding the reinforcing materials into the extruder 16 and/or the reinforcing materials can be added or mixed during any stage of the extrusion process. The molten thermoplastic within the extruder 16 has any suitable melt temperature. In certain embodiments, the molten thermoplastic within the extruder 16 typically has a melt temperature ranging between about 240 ° C. to about 290 ° C.

As shown in FIG. 1A, the guiding system 10 further includes a container 48 disposed downstream to the extruder 16 with the container 48 filled with fluid for receiving and cooling the strands 14, 15. Typically, the fluid is further defined as water. However, it has been contemplated that the container 48 can be filled with any suitable fluid for cooling the strands 14, 15. Once the strands 14, 15 are extruded through the die plate 46 of the extruder 16, the strands 14, 15 begin to air cool before the strands 14, 15 are further cooled in the water of the container 48. The strands 14, 15 exiting the die plate 46 of the extruder 16, i.e., before entering the water of the container 48, can be any suitable temperature and typically have a temperature ranging between about 240 ° C. to about 290 ° C. The temperature of the water in the container 48 can be any suitable temperature and typically ranges between about 10 ° C. to about 38 ° C. The water is continuously cooled through a closed loop re-circulating heat exchanger device. It has also been contemplated that the length of the container 48 can vary depending on the desired amount of cooling required for the strands 14, 15.

Also referring to FIG. 1B, the guide segments 22, 24 are disposed on the support 20 and abut each other along the longitudinal axis L to define one strand guide assembly 12 with the support 20 coupled to the container 48 and defining the longitudinal axis L. The strand guide assembly 12 coupled to the container 48 will be referred to as a first strand guide assembly 50. The guide segments 22, 24 are at least partially submerged in the fluid of the container 48 for cooling the strands 14, 15. Each of the guide segments 22, 24 of the first strand guide assembly 50 are formed of the ceramic material and have the first end 26, the second end 28, and the shaped step 30 defined between the first and second ends 26, 28 as discussed above. The shaped step 30 of each of the guide segments 22, 24 of the first strand guide assembly 50 are configured for receiving one of the strands 14, 15 to separate the strands 14, 15. Typically, the shaped step 30 of each of the guide segments 22, 24 of the first strand guide assembly 50 is further defined as the L-shaped step 30 defined between the first and second ends 26, 28 for guiding the strands 14, 15 across the L-shaped step 30. The L-shaped step 30 ensures separation of the strands 14, 15 as well as proper cooling of the strands 14, 15.

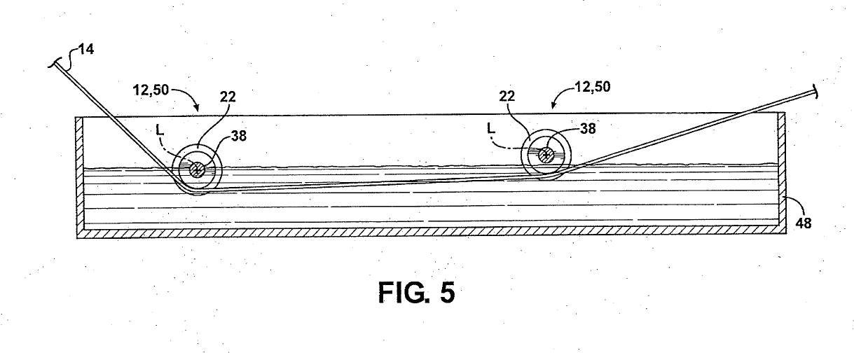

As shown in FIGS. 1A and 5, typically, the first strand guide assembly 50 is further defined as a plurality of first strand guide assemblies 50 coupled to the container 48 such that the strands 14, 15 are guided under the first strand guide assemblies 50 and through the water for cooling the strands 14, 15. More typically, the supports 20 of the first strand guide assemblies 50 are coupled to the container 48. As best shown in FIG. 5, the first strand guide assemblies 50 are spaced from each other within the container 48 with one of the first strand guide assemblies 50 disposed deeper in the water of the container 48 than the other one of the first strand guide assemblies 50. In other words, the guide segments 22, 24 of one of the first strand guide assemblies 50 are submerged deeper in the water of the container 48 than the guide segments 22, 24 of the other one of the first strand guide assemblies 50. It has been contemplated that both of the first strand guide assemblies 50 can be partially or completely submerged in the water. The number of the first strand guide assemblies 50 coupled to the container 48 can change according to the length of the container 48 and the desired amount of cooling required for the strands 14, 15.

Referring back to FIG. 1A, the guiding system 10 also includes a strand tree 52 disposed downstream to the extruder 16. In addition, in certain embodiments, the strand tree 52 is disposed downstream to the container 48. The strands 14, 15 are guided over the strand tree 52 for cooling and/or drying the strands 14, 15 with air. Typically, ambient air is utilized to cool and/or dry the strands 14, 15 guided over the strand tree 52. However, any other suitable fluid can be utilized to cool and/or dry the strands 14, 15 guided over the strand tree 52. Also, the strands 14, 15 are guided over the strand tree 52 to ensure separation of the strands 14, 15 for preventing the strands 14, 15 from crossing over each other which would cause moisture to maintain in the strands 14, 15. The strand tree 52 also ensures proper cooling of the strands 14, 15.

The supports 20 each define the longitudinal axis L and are coupled to the strand tree 52 with the guide segments 22, 24 disposed on the supports 20. The guide segments 22, 24 abut each other on the supports 20 along the longitudinal axis L to define a plurality of strand guide assemblies 12 for cooling the strands 14, 15. The strand guide assemblies 12 coupled to the strand tree 52 will be referred to as a plurality of second strand guide assemblies 54. Each of the guide segments 22, 24 of the second strand guide assemblies 54 are formed of the ceramic material and have the first end 26, the second end 28, and the shaped step 30 defined between the first and second ends 26, 28 as discussed above. The shaped step 30 of each of the guide segments 22, 24 of the second strand guide assemblies 54 are configured for receiving one of the strands 14, 15 to separate the strands 14, 15. Typically, the shaped step 30 of each of the guide segments 22, 24 of the second strand guide assemblies 54 are further defined as the L- shaped step 30 defined between the first and second ends 26, 28 for guiding the strands 14, 15 across the L-shaped step 30. The L-shaped step 30 ensures separation of the strands 14, 15 as well as proper cooling of the strands 14, 15.

As best shown in FIG. 1C, the second strand guide assemblies 54 are coupled to the strand tree substantially parallel to each other in a row. In other words, the strand tree 52 includes a frame 56 with each of the second strand guide assemblies 54 coupled to the frame 56 in the row. In other words, the supports 20 of the second strand guide assemblies 54 are coupled to the frame 56 in the row. The number of the second strand guide assemblies 54 utilized for guiding the strands 14, 15 can change depending on the desired amount of cooling required for the strands 14, 15. For example, a large number of second strand guide assemblies 54 can be utilized if the strands 14, 15 require additional cooling before entering the finishing apparatus 18. As another example, a fewer number of second strand guide assemblies 54 can be utilized if the temperature of the strands 14, 15 are appropriate for entering the finishing apparatus 18.

Referring to FIGS. 1A and 1D, in certain embodiments, the guiding system 10 also includes a blower 58 disposed between the container 48 and the strand tree 52 for circulating air about the strands 14, 15. Typically, the blower 58 circulates ambient air about the strands 14, 15 which cools and/or dries the strands 14, 15. It has been contemplated that the blower 58 can circulate cool air or any other suitable temperature of air. It has also been contemplated that any suitable fluid can be utilized for circulating about the strands 14, 15. As one example, the blower 58 can be defined as an air knife as known to one skilled in the art. The strands 14, 15 exiting the water of the container 48, i.e., before entering the blower 58, can be any suitable temperature and the strands 14, 15 exiting the blower 58 can be any suitable temperature.

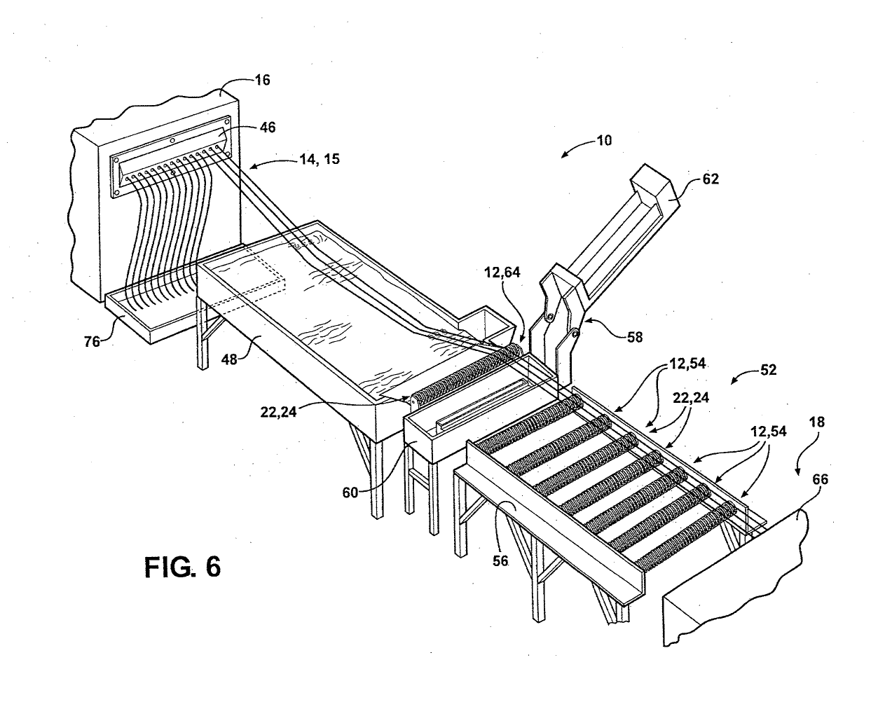

Referring to FIG. 6, the blower 58 typically includes a lower portion 60 and an upper portion 62 rotatably attached to the lower portion 60 for opening the blower 58. The upper portion 62 is rotated away from the lower portion 60 such that the strands 14, 15 can be routed through the blower 58 and toward the strand tree 52 during extrusion of a first batch of molten thermoplastic, which is discussed further below.

Referring back to FIG. 1D, the support 20 defining the longitudinal axis L is coupled to the blower 58. The guide segments 22, 24 are disposed on the support 20 and abut each other along the longitudinal axis L to define another strand guide assembly 12. The strand guide assembly 12 coupled to the blower 58 will be referred to as a third strand guide assembly 64. Typically, the support 20 is coupled to the lower portion 60 of the blower 58. The strands 14, 15 are guided over the third strand guide assembly 64 for preventing the strands 14, 15 from engaging the blower 58. Each of the guide segments 22, 24 of the third strand guide assembly 64 are formed of the ceramic material and have the first end 26, the second end 28, and the shaped step 30 defined between the first and second ends 26, 28 as discussed above. The shaped step 30 of each of the guide segments 22, 24 of the third strand guide assembly 64 are configured for receiving one of the strands 14, 15 to separate the strands 14, 15. Typically, the shaped step 30 of each of the guide segments 22, 24 of the third strand guide assembly 64 is further defined as the L-shaped step 30 defined between the first and second ends 26, 28 for guiding the strands 14, 15 across the L-shaped step 30. The L-shaped step 30 ensures separation of the strands 14, 15 as well as proper cooling of the strands 14, 15.

Each of the guide segments 22, 24 of each of the first, second, and third strand guide assemblies 50, 54, 64 are identical in configuration as discussed above. Each of the guide segments 22, 24 of each of the first, second, and third strand guide assemblies 50, 54, 64 are reversible on respective supports 20 to define the single-step configuration presenting one of the shaped steps 30 for receiving the strands 14, 15 of the first diameter D₁ or the dual-step configuration presenting the abutting pair of the shaped steps 30 for receiving the strands 14, 15 of the second diameter D₂. More typically, the single-step configuration presents one of the L-shaped steps 30 for receiving the strands 14, 15 of the first diameter D₁ and the dual-shaped configuration presents one of the L-shaped steps 30 abutting another one of the L-shaped steps 30 for receiving the strands 14, 15 of the second diameter D₂. In other words, each of the guide segments 22, 24 of each of the first, second, and third strand guide assemblies 50, 54, 64 are reversible between the single-step configuration and the dual-step configuration to correspond with the strands 14, 15 of the first and second diameters D₁, D₂.

For example, if all of the strands 14, 15 extruded from the extruder 16 are of the first diameter D₁, then all of the guide segments 22, 24 of the first, second, and third strand guide assemblies 50, 54, 64 will be in the single-step configuration. Therefore, when in the single-step configuration, there will be one strand 14, 15 per each L-shaped step 30 of the guide segments 22, 24 of the first, second, and third strand guide assemblies 50, 54, 64. As another example, if all of the strands 14, 15 extruded from the extruder 16 are of the second diameter D₂, then all of the guide segments 22, 24 of the first, second, and third strand guide assemblies 50, 54, 64 will be in the dual- step configuration. Therefore, when in the dual-step configuration, there will be one strand 14, 15 per cooperating pair of L-shaped steps 30 of the guide segments 22, 24 of the first, second, and third strand guide assemblies 50, 54, 64. As yet another example, if the strands 14, 15 extruded from the extruder 16 have both the first and second diameters D₁, D₂, then the guide segments 22, 24 of the first, second, and third strand guide assemblies 50, 54, 64 will be in both the single-step and dual-step configurations to correspond with the first and second diameters D₁, D₂ of the strands 14, 15.

Referring to FIGS. 1A, 1C, and 7, the guiding system 10 further includes the finishing apparatus 18 as briefly discussed above. The finishing apparatus 18 is disposed downstream to the extruder 16, the container 48, and the strand tree 52 for preparing the strands 14, 15 for delivery to a customer. The strands 14, 15 entering the finishing apparatus 18 can be any suitable temperature. The finishing apparatus 18 can include multiple components for preparing the strands 14, 15 for delivery to the customer. For example, as shown in FIGS. 1A, 1C, 6, and 7, the finishing apparatus 18 optionally includes a pelletizer 66 for cutting the strands 14, 15 into pellets. As another example, as shown in FIG. 7, the finishing apparatus 18 can also optionally include a fluid bed cooler 68, a spiral 70, a holding tank 72, a finishing product tank 74, or any combination of these components, as known to one skilled in the art.

When extruding the first batch of molten thermoplastic, the strands 14, 15 are routed from the extruder 16 to the finishing apparatus 18 by hand. As shown in FIG. 6, a tray 76 is disposed between the extruder 16 and the container 48 such that the strands 14, 15 are extruded through the die plate 46 and into the tray 76. Initially, the first strand guide assemblies 50 are removed from the container 48 and the upper portion 62 of the blower 58 is rotated away from the lower portion 60. A user takes one or more of the strands 14, 15 and typically three strands 14, 15 and routes or guides the strands 14, 15 through the water of the container 48, over the third strand guide assembly 64, through the blower 58 and over the second strand guide assemblies 54 of the strand tree 52. The three strands 14, 15 are then routed into the finishing apparatus 18. The three strands 14, 15 are merely for illustrative purposes; therefore, as mentioned above more or less than three strands 14, 15 can initially be routed into the finishing apparatus 18.

Once the three strands 14, 15 are routed into the finishing apparatus 18, the first strand guide assemblies 50 are secured to the container 48 and are at least partially submerged in the water with each of the strands 14, 15 disposed in the respective L-shaped step 30 of the guide segments 22, 24 for separating the strands 14, 15. The upper portion 62 of the blower 58 remains open while the rest of the strands 14, 15 are routed or guided under the first strand guide assemblies 50, through the water of the container 48, over the third strand guide assembly 64, through the blower 58, over the second strand guide assemblies 54 of the strand tree 52, and into the finishing apparatus 18. When all of the strands 14, 15 are routed to the finishing apparatus 18, the upper portion 62 of the blower 58 is rotated toward the lower portion 60 to close the blower 58. Once the strands 14, 15 are routed to the finishing apparatus 18, the finishing apparatus 18 will continuously pull the strands 14, 15 from the extruder 16 toward the finishing apparatus 18.

The present invention also discloses a method of controlling a flow of molten thermoplastic to form at least the first strand 14 and the second strand 15 moving from the extruder 16 having the die plate 46 to the finishing apparatus 18. Typically, the finishing apparatus 18 includes the pelletizer 66 and further comprising the step of cutting the strands 14, 15 with the pelletizer 66.

The method comprises the steps of extruding the molten thermoplastic through the die plate 46 to form the strands 14, 15 and routing the strands 14, 15 from the extruder 16 to the finishing apparatus 18. The method further comprises the step of guiding the first strand 14 across the one of the shaped steps 30 when the guide segments 22, 24 are in the single-step configuration or guiding the first strand 14 across the abutting pair of the shaped steps 30 when the guide segments 22, 24 are in the dual-step configuration to separate the first strand 14 from the second strand 15. The method also comprises the step of guiding the second strand 15 across another one of the shaped steps 30 when the guide segments 22, 24 are in the single-step configuration or guiding the second strand 15 across another abutting pair of the shaped steps 30 when the guide segments 22, 24 are in the dual-step configuration to separate the second strand 15 from the first strand 14.

In certain embodiments, the method further comprises the step of adding the reinforcing material to the molten thermoplastic, wherein the reinforcing material is selected from the group of glass, minerals, and combinations thereof. In addition, in certain embodiments, the molten thermoplastic is further defined as molten nylon and the step of extruding the molten thermoplastic is further defined as the step of extruding the molten nylon through the die plate 46 to form the strands 14, 15. Additionally, in certain embodiments, the method comprises the step of adding the reinforcing material to the molten nylon, wherein the reinforcing material is selected from the group of glass, minerals, and combinations thereof.

The method also comprises the step of cooling the strands 14, 15. Typically, the step of cooling the strands 14, 15 is further defined as the step of cooling the strands 14, 15 in water and the step of cooling the strands 14, 15 in air. More typically, the step of cooling the strands 14, 15 in air occurs before and after the step of cooling the strands 14, 15 in water.

In certain embodiments, the step of cooling the strands 14, 15 is further defined as the step of cooling the strands 14, 15 in the water of the container 48. In other words, the method further comprises the step of submerging the first strand guide assembly 50 at least partially in the water of the container 48 such that the strands 14, 15 are guided across the shaped step 30 of the guide segments 22, 24 under the first strand guide assembly 50 and through the water. Typically, the first strand guide assembly 50 is further defined as the plurality of first strand guide assemblies 50 spaced from each other and further comprising the step of submerging the first strand guide assemblies 50 at least partially in the water of the container 48 such that the strands 14, 15 are guided across the shaped step 30 of the guide segments 22, 24 under the first strand guide assemblies 50 and through the water. In one embodiment, the method further comprises the step of submerging one of the first strand guide assemblies 50 deeper in the water than another one of the first strand guide assemblies 50.

In one embodiment, the blower 58 is adjacent the container 48 to circulate air and the step of cooling the strands 14, 15 in the water of the container 48 occurs before the step of cooling the strands 14, 15 with the air of the blower 58. Typically, the method further comprises the steps of routing the strands 14, 15 through the blower 58 and circulating air about the strands 14, 15 as the strands 14, 15 move through the blower 58. In addition, the method further comprises the step of guiding the strands 14, 15 over the third strand guide assembly 64 before the step of routing the strands 14, 15 through the blower 58.

In certain embodiments, the step of cooling the strands 14, 15 is further defined as the step of cooling the strands 14, 15 guided through the strand tree 52 with air. The strand tree 52 is adjacent the blower 58 and the steps of cooling the strands 14, 15 in the water of the container 48 and cooling the strands 14, 15 in the air of the blower 58 occurs before the step of cooling the strands 14, 15 in the strand tree 52 with air. The second strand guide assemblies 54 are substantially parallel to each other in the row and the method further comprises the step of guiding the strands 14, 15 over the second strand guide assemblies 54 of the strand tree 52.

The method optionally further comprises the step of arranging the guide segments 22, 24 on the support 20 in the single-step configuration to correspond with the first diameter D₁ of the strands 14, 15. The method also optionally further comprises the step of arranging the guide segments 22, 24 on the support 20 in the dual-step configuration to correspond with the second diameter D₂ of the strands 14, 15. In other words, it has been contemplated that the method can further comprise the step of arranging the guide segments 22, 24 of the first, second, and third strand guide assemblies 50, 54, 64 to correspond with at least one of the first and second diameters D₁, D₂ of the strands 14, 15. In addition, the method optionally comprises the step of replacing at least one of the guide segments 22, 24 on the support 20, when damaged. In other words, it has been contemplated that the method can further comprise the step of replacing at least one of the guide segments 22, 24 of the first, second, and third strand guide assemblies 50, 54, 64 when damaged.

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment can become apparent to those skilled in the art and do come within the scope of the invention. Accordingly, the scope of legal protection afforded this invention can only be determined by studying the following claims.

What is claimed is:

1. A method of controlling a flow of molten thermoplastic to form at least a first strand and a second strand moving from an extruder having a die plate to a finishing apparatus with a plurality of guide segments each having a first end, a second end, and a shaped step defined between the first and second ends and each formed of a ceramic material and abutting each other on a support with the guide segments configured on the support to define a single-step configuration presenting one of the shaped steps and a dual-step configuration presenting an abutting pair of the shaped steps, said method comprising the steps of:
extruding the molten thermoplastic through the die plate to form the strands;
routing the strands from the extruder to the finishing apparatus;
guiding the first strand across the one of the shaped steps when the guide segments are in the single-step configuration or guiding the first strand across the abutting pair of the shaped steps when the guide segments are in the dual-step configuration to separate the first strand from the second strand;
guiding the second strand across another one of the shaped steps when the guide segments are in the single-step configuration or guiding the second strand across another abutting pair of the shaped steps when the guide segments are in the dual-step configuration to separate the second strand from the first strand; and
cooling the strands.

2. A method as set forth in claim 1 wherein the step of cooling the strands is further defined as the step of cooling the strands in water and the step of cooling the strands in air.

3. A method as set forth in claim 2 wherein the step of cooling the strands in air occurs before and after the step of cooling the strands in water.

4. A method as set forth in claim 3 further including a container filled with water, and a blower adjacent the container to circulate air and wherein the step of cooling the strands in the water of the container occurs before the step of cooling the strands with the air of the blower.

5. A method as set forth in claim 4 further including a strand tree adjacent the blower and wherein the step of cooling the strands in the water of the container and the step of cooling the strands in the air of the blower occurs before the step of cooling the strands in the strand tree with air.

6. A method as set forth in claim 1 further including a container filled with water and wherein the step of cooling the strands is further defined as the step of cooling the strands in the water of the container.

7. A method as set forth in claim 6 wherein the guide segments and the support define a strand guide assembly and further comprising the step of submerging the strand guide assembly at least partially in the water of the container such that the strands are guided under the strand guide assembly and through the water.

8. A method as set forth in claim 7 wherein the strand guide assembly is further defined as a plurality of strand guide assemblies spaced from each other and further comprising the step of submerging the strand guide assemblies at least partially in the water of the container such that the strands are guided under the strand guide assemblies and through the water.

9. A method as set forth in claim 1 wherein the guide segments and the support define a strand guide assembly with the strand guide assembly further defined as a plurality of strand guide assemblies and further including a strand tree with the strand guide assemblies coupled to the strand tree substantially parallel to each other in a row and further comprising the step of guiding the strands over the strand guide assemblies of the strand tree and wherein the step of cooling the strands is further defined as the step of cooling the strands guided over the strand tree with air.

10. A method as set forth in claim 1 further including a blower and further comprising the step of routing the strands through the blower and the step of circulating air about the strands as the strands move through the blower and wherein the guide segments and the support define a strand guide assembly with the support coupled to the blower and further comprising the step of guiding the strands over the strand guide assembly before the step of routing the strands through the blower.

11. A method as set forth in claim 1 wherein the strands have a first diameter and further comprising the step of arranging the guide segments on the support in the single-step configuration to correspond with the first diameter of the strands.

12. A method as set forth in claim 1 wherein the strands have a second diameter larger than a first diameter and further comprising the step of arranging the guide segments on the support in the dual-step configuration to correspond with the second diameter of the strands.

13. A method as set forth in claim 1 further comprising the step of replacing at least one of the guide segments on the support when damaged.

14. A guiding system having a plurality of strands formed of a molten thermoplastic with the strands defining at least one of a first diameter and a second diameter larger than the first diameter, said system comprising:
an extruder for extruding the molten thermoplastic to form the strands;
a container disposed downstream to said extruder and filled with fluid for receiving the strands;
a support defining a longitudinal axis and coupled to said container;
a plurality of guide segments disposed on said support and abutting each other along said longitudinal axis to define a first strand guide assembly at least partially submerged in said fluid of said container for cooling the strands;
each of said guide segments of said first strand guide assembly are formed of a ceramic material and have a first end, a second end, and a shaped step defined between said first and second ends with said shaped step of each of said guide segments of said first strand guide assembly configured for receiving one of the strands to separate the strands;
a strand tree disposed downstream to said extruder and having a plurality of supports each defining a longitudinal axis and a plurality of guide segments disposed on said supports and abutting each other along said longitudinal axis to define a plurality of second strand guide assemblies for cooling the strands;
each of said guide segments of said second strand guide assemblies are formed of a ceramic material and have a first end, a second end, and a shaped step defined between said first and second ends with said shaped step of each of said guide segments of said second strand guide assemblies configured for receiving one of the strands to separate the strands; and
a finishing apparatus disposed downstream to said extruder, said container, and said strand tree for preparing the strands for delivery to a customer.

15. A system as set forth in claim 14 further including a blower disposed between said container and said strand tree for circulating air about the strands.

16. A system as set forth in claim 15 wherein said strand tree is disposed downstream to said container.

17. A system as set forth in claim 15 further including a support defining a longitudinal axis and coupled to said blower and further including a plurality of guide segments disposed on said support and abutting each other along said longitudinal axis to define a third strand guide assembly with the strands guided over said third strand guide assembly and wherein each of said guide segments of said third strand guide assembly are formed of a ceramic material and have a first end, a second end, and a shaped step defined between said first and second ends with said shaped step of each of said guide segments of said third strand guide assembly configured for receiving one of the strands to separate the strands.

18. A system as set forth in claim 17 wherein each of said guide segments of each of said first, second, and third strand guide assemblies are reversible on respective supports to define a single-step configuration presenting one of said shaped steps for receiving the strands of the first diameter or a dual-step configuration presenting an abutting pair of said shaped steps for receiving the strands of the second diameter.

19. A system as set forth in claim 18 wherein said shaped step of each of said guide segments of said first, second, and third strand guide assemblies are further defined as an L-shaped step defined between said first and second ends such that said single-step configuration presents one of said L-shaped steps for receiving the strands of the first diameter and said dual-step configuration presents one of said L-shaped steps abutting another one of said L-shaped steps for receiving the strands of the second diameter.

20. A strand guide assembly for guiding at least one strand extruded from an extruder with the strand having one of a first diameter and a second diameter larger than the first diameter, said assembly comprising:
a support defining a longitudinal axis;
a first guide segment and a second guide segment each disposed on said support and abutting each other along said longitudinal axis with each of said first and second guide segments formed of a ceramic material;
said first and second guide segments each have a first end and a second end spaced from each other along said longitudinal axis with said first and second guide segments each having a step defined between said first and second ends of each of said first and second guide segments for guiding the strand; and
said first and second guide segments are reversible between a single-step configuration presenting said first end of said first guide segment abutting said second end of said second guide segment for guiding the strand of the first diameter across said step of said first guide segment and a dual-step configuration presenting said first end of said first guide segment abutting said first end of said second guide segment with said step of each of said first and second guide segments abutting each other for guiding the strand of the second diameter across said step of each of said first and second guide segments.

21. An assembly as set forth in claim 20 wherein said step of each of said first and second guide segments are further defined as an L-shaped step defined between said first and second ends for guiding the strand across said L-shaped step.

22. An assembly as set forth in claim 21 wherein said L-shaped step of each of said first and second guide segments include a vertical portion and a horizontal portion abutting each other with said vertical portion disposed transverse to said longitudinal axis and said horizontal portion disposed substantially parallel to said longitudinal axis between said vertical portion and said first end.

23. An assembly as set forth in claim 22 wherein said first end of said first and second guide segments abut each other with said horizontal portion of said first and second guide segments aligning with each other such that said L-shaped step of each of said first and second guide segments cooperate for guiding the strand of the second diameter.

24. An assembly as set forth in claim 22 wherein said first end of said first guide segment abuts said second end of said second guide segment with said horizontal portion of said first guide segment spaced from said horizontal portion of said second guide segment such that said L-shaped step of said first guide segment guides the strand of the first diameter.

25. An assembly as set forth in claim 20 wherein said first and second ends of each of said first and second guide segments define a flat configuration with said flat configuration of one of said first and second ends of said first guide segment abutting said flat configuration of said second end of said second guide segment such that each of said first and second guide segments define only a singular step for guiding the strand of one of the first and second diameters.
